(19) United States
(12) Patent Application Publication
(10) Pub. No.: US 2003/0037139 A1
(43) Pub. Date: Feb. 20, 2003

(54) Content distribution model

(75) Inventor: Yevgeniy Eugene Shteyn, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/933,601

(22) Filed: Aug. 20, 2001

(51) Int. Cl. G06F 15/173; G06F 15/16

(52) U.S. Cl. 709/225; 709/201

(57) ABSTRACT

A broker of the invention proposes a centralized distribution scheme for the consumer electronics market. This distribution scheme comprises an electronic presentation of a plurality of information services, among which an individual can choose. Each information service is offered by one or more service providers. Upon selection by the individual of a specific service, the broker enables one of the providers associated with the specific service to provide the service to the individual. The broker may have a database of records of service providers. Besides, the broker may also build a profile of the user so that the provider can be selected based on a match of the record of the provider with the profile.

### FIELD OF THE INVENTION

The invention relates to information distribution. The invention is pertinent to entertainment services and content distributed via end-user equipment.

### BACKGROUND ART

As the number of networked devices increases and as network bandwidth also increases, the value of business models that incorporate providing software and services to consumers is growing relative to the value of traditional business models based on hardware sales alone. Nowadays priority is given to personalization and customization of content and services. Service providers compete to gain user's attention and once a user selects one of the service providers, the user eventually may become locked within a set of offerings and proprietary features of the provider. This tends to be particularly applicable in the consumer electronics (CE) space.

The integration of devices in a home environment is also becoming increasingly common. Several network architectures or technologies, e.g. Jini, UTPnP, HAVI and the Bluetooth standard, have been developed to enhance the interoperability of multiple devices in a network. These various architectures enable the user to access a variety of information and entertainment sources conveniently. However the new ability of devices to communicate with each other has obliged service providers to build alliances to deliver a broader range of information services.

Thus, multiple services compete for user attention by providing, for example, customized content, book and movie recommendations and personalized electronic program guides. Explicitly or implicitly expressed, user preferences allow service providers to deliver better targeted advertisements, retain and attract new customers and increase the scope and reach of their offerings. A service provider's control over customer preferences and related information significantly reduces the ability of the user to switch between competing providers. This dependency increases as the provider supplies software applications, content decoders and other means enabling content access, rendering or integration. A “walled garden” is created around the user, whose choices for other enhanced multimedia experiences are thus typically limited.

### SUMMARY

It is an object of the invention to provide an information services distribution model for the CE environment. It is a further object of the invention to improve the ease of selection and transition between multiple content providers.

To this end, a business method of the invention relates to an information distribution service offered to an individual. The method comprises electronically presenting to the individual a plurality of services that the individual can choose from. Each service is respectively offered by one or more providers. A request is received from the individual for a specific one of the services. A selected provider is then enabled to provide the specific service to the individual.

In a method of the invention, a “broker” gathers available information services and corresponding providers and electronically presents these services to the individual. In the invention, the terminology “information services” refers to services related to the delivery of any type of content, applications or software to the individual via the individual's applicances. The broker may supply the individual with an electronic information distribution portal or interface presenting the plurality of services. The electronic interface does not necessarily identify the one or more providers associated with a respective service. In this case, the individual selects the service and thereafter, the broker selects a given provider who will be supplying the service to the individual. In this embodiment, services are offered to the individual in a content provider independent manner. In an embodiment, the broker selects a given service provider from a comparison of characteristics of the provider's services with a profile of the individual. In another embodiment some or all service providers are identified on the interface so that the individual can select the provider of his choice.

### BRIEF DESCRIPTION OF THE DRAWINGS

The invention is explained in further details, by way of examples, and with reference to the accompanying drawings wherein:

FIG. 1 illustrates an information distribution system in accordance with the invention; and,

FIG. 2 is a block diagram of an example embodiment of the invention.

Elements within the drawing having similar or corresponding features are identified by like reference numerals.

### DETAILED DESCRIPTION

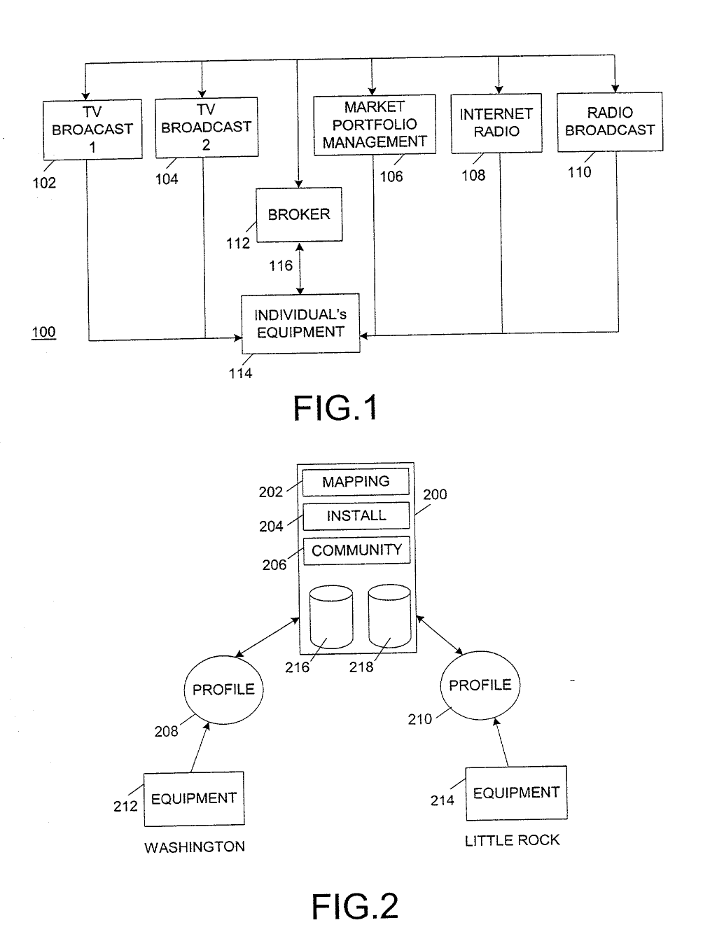

FIG. 1 shows an information distribution system 100 illustrating an information services distribution model of the invention. The information distribution system 100 includes five service providers: a first television broadcaster 102, a second television broadcaster 104, a provider 106 of a market portfolio management service, an internet radio provider 108 and a radio broadcaster 110. The system 100 also includes an individual's equipment 114 and information distribution broker 112.

The individual's equipment 114 may be a single CE device at the individual's personal home, a personal cellphone or a personal digital assistant. The equipment 114 can also represent a plurality of interconnected or stand alone devices at the individual's home. In another embodiment, the equipment 114 represents a home network as defined in one of the well-known in the art network architectures and protocols of industry consortiums, e.g. UPnP, HAVI, JIM, CORBA. Devices external to a home network can communicate with devices in the home network via a home gateway or entry point to the home network. The system 114 may also represent such a gateway or entry point to the home network of the individual.

The broker 112 acts as an intermediary party between the providers 102-110 and the equipment 114. The broker 112 electronically presents a plurality of services to the individual using an electronic interface 116. As used herein, “interface” may represent an electronic document presenting the plurality of services. Conventionally, an interface represents a set of dials, knobs, operating system commands, graphical display formats, and other devices provided by a computer or a program to allow the user to communicate and use the computer or program. The interface 116 is a starting point for the individual with regards to the delivery of services to his equipment 114. In the World Wide Web technology, a portal is a Web site that is or proposes a major starting site for users when they get connected to the Web. The interface 116 may be implemented as a Web portal and transmitted to the equipment 114 over the Internet. In another embodiment, the interface 116 is distributed via a phone line in a point to point communication from the broker 112 to the equipment 114 after dial-up by the equipment 114 to the broker 112. The interface 116 electronically presents the variety of services, to which the individual may eventually subscribe. These services relate to information distribution. As used herein, information distribution comprises distribution of a plurality of discrete segments of materials, e.g. individual songs, movies, sport events, news stories, Web pages, pictures, software applications and electronic program guides. In this embodiment, the interface 116 presents at least three different general services: market portfolio management, radio entertainment and TV program broadcast. The individual can choose among these or other general services and have them delivered to his equipment 114. Each general service is offered by one or more service providers. In the invention, upon selection by the individual of a specific one of the three services, the broker 112 selects one of the providers 102-110 to provide the service to the individual via the equipment 114.

In an embodiment of the invention, the broker 112 builds or has access to a profile of the individual. The profile may comprise preferences of the individual with respect to available information services, statistics on the individual, personal data of the individual such as where the individual leaves, composition of the household and the like. The profile may also comprise a configuration and features of the equipment 114, connection bandwidth and current information services providers. The profile may have been built explicitly by the individual or implicitly based on known data or statistics with respect to the individual's preferences and behavior. The profile may be stored at the broker's 112 or at the individual's. The broker 112 also accesses a database of records of characteristics of available services and corresponding service providers. A record for a given service or given provider may comprise a description of the service giving, for example, the type of information delivered, geographic areas where the service is available, prices, major constraints in the service agreement such as minimum of 1 year service subscription, and whether another CE device is needed to receive the information service.

Once the individual has shown interest for a specific service, the broker compares the profile of the individual with records of providers offering the specific service. Based on the comparison, the broker 112 selects one of the providers and enables the selected provider to deliver the service as requested by the individual. Based on the comparison, the broker 112 may also pre-select a few providers, for which the respective records sufficiently match the profile of the individual. The individual is then presented with this list of pre-selected providers to make his choice.

In this embodiment, the individual selects the radio entertainment service. The service provider 110 offers a live radio broadcast with local and national news every 15 minutes featuring, for example, traffic and weather information. The provider 108 offers a customized radio service over the Internet rendering possible for the user to choose the type of music and the artists being played. The profile of the individual indicates that the individual only listens to the radio in the morning before going to work and that the individual is interested in receiving traffic information. The broker 112 estimates that the provider 110 could provide the best service considering the individual's interests relatively to other radio entertainment providers' offerings. Thus, the broker 112 enables the provider 110 to provide the radio service to the individual. For example, the broker 112 configures the equipment 114 to receive radio programs broadcast by the provider 110, e.g., the broker 112 indicates the frequency of the broadcast.

In the same manner, the individual has indicated in his profile his preferences in terms of television programs, movies and shows. From the profile and respective records of the providers 102 and 104, the broker 112 selects the TV broadcaster 102 or 104 who will best satisfy the individual's interests. Advantage can be taken from such a business model in the sense the user can henceforth choose only TV channels in which he is interested. The user is not obliged to subscribe to a predefined package of various channels, with one or more channels ending up being of no interest to the user.

In an information services distribution model of the invention, providers may supply content and material to the equipment 114 via their own existing communication network. In this embodiment, the providers are not mandated to convey material to the equipment 114 via a communication network of the broker 112. For example, the broker 112 may enable the user to receive and access a given service by providing the individual with a decoder and an associated password. Then, the provider broadcasts content over his own television or radio network. Generally broadcast includes any method of conveying information without a specific identification of the intended recipient or without regard for whether an identified recipient receives the communicated material. Providers may also distribute information via a peer-to-peer communication network over the Internet. Some providers may also stream content over the Internet. Thus, providers may deliver information over different respective information distribution networks, to which the equipment 114 of the individual is connected.

In addition, once a provider has been selected, either by the individual himself or by the broker 112, to provide a specific information service, the individual may deal directly with the provider without having to go through the broker 112. In this embodiment, the broker 112 initiates the information service relationship only. In another embodiment, whenever possible, the identity of the provider is not revealed to the individual and the individual receives content and material from the provider but deals with the broker 112 directly as to customer support for example.

FIG. 2 illustrates a scenario of the individual moving from one geographical location to another. The individual is initially located at a first geographical location (Washington, D.C.) and receives information services via equipment 212. The individual is moving to a different location (Little Rock Ark.), where the individual is equipped with equipment 214 for receiving information services. In Washington, the individual has subscribed to a first set of information services. Details on this first set of information services are stored in a profile 208 of the individual. The profile 208 may also include, as mentioned previously, preferences of the individual, configuration of equipment 212 and network bandwidth in Washington. The individual should receive in Little Rock a second set of information services that needs to be determined.

The broker 112 has a system 200 including various application modules to manage and organize the delivery of services from providers to individuals. A first mapping application 202 allows mapping the service providers with the individual's requests for services. The application 202 generates a new profile 210 of the individual associated with the second location, Little Rock, and equipment 214. The profile 210 is generated based on the profile 208 temporarily stored in a profile database 216. The profile 210 can also be generated based on a database 218 of records of information services and corresponding providers. The database 218 may be a global database where records for nation-wide available services and information service providers are stored. In another embodiment, the database 218 only includes records of locally available services and corresponding providers. The profile 210 can also be generated based on the equipment 214 and new requests or input from the individual. The new profile 210 is stored in the database 216 replacing the profile 208. The profile 210 may be downloaded to the equipment 214 for further reference. The profile 210 may also be used to configure features of the equipment 214. For example, the profile 210 may be used to automatically enable the download of software and customized application to the equipment 214.

To this end, a custom installation application 204 of the system 200 enables installation and integration of material in the equipment 214. The application 204 defines new settings for the equipment 214 necessary for the new set of services. The application 204 may enable the new configuration of the equipment 214 through an HTML page or a set of pages including various scripts for configuration of the equipment 214. In this context, a script is a program or sequence of instructions that is interpreted or carried out by another program rather than by a computer processor. For example, the web page may comprise JavaScripts or Java applets that the individual activates in order to set up the equipment 214.

In this embodiment, equipment 212 and 214 represent respective UPnP-compliant home networks 212 and 214. In Washington, the individual was provided with a graphical user interface with embedded scripts for control and configuration of devices in the network 212. The scripts may be run locally in a controlling device in the network 212 or remotely in a device external to the network 212. The various scripts identify the individual's preferred American TV sport broadcasts and a UI layout with additional enhancement features such as players profiles. For example, when the individual selects his favorite sport program on the UI, a controller in the network 212 executes the corresponding script and transmits the channel and time of broadcast to a digital video recorder for recording. In this embodiment, the installation application 204 generates new scripts for the control of devices in the UPnP network 214. These scripts may be generated based on the scripts used for the control of network 212. In Little Rock, the individual's favorite sport program is not broadcast, however a different service provider offers to download the same sport program over the Internet. The mapping application 202 maps the equipment 214 with this service provider. Thereafter, the installation application 204 enables downloading a new script in a controller of the network 214. The new script enables the controller to control devices in the network 214 to record or play out programs downloaded from the service provider over the Internet. Thus, when the individuals selects his favorite sport program for recording, the controller in the network 214 executes the new script and transmits an IP address of the service provider to a digital video device connected to the Internet.

The system 200 further includes a third community application 206. The application 206 enables experience sharing and material or information exchange among individuals. The application 206 enables individuals to share their preferences through sharing of their respective profiles for example. Part of the profile 210 of the individual stored in the database 216 may be made available to the application 206 and rendered public. The application 206 may organize shared data by topics, individuals' locations, providers or information services.

The broker 112 may also periodically inform users of special offers for specific information services based on the actual circumstances. These offers may be limited in time and permit to dynamically adapt services to the current networks capacities, specific events or the like. For example, if the network bandwidth is underutilized at a given time, the broker 112 may offer for a limited period of time a movie streaming sale to take advantage of the availability in bandwidth. These offers may be posted using the community application 206.

The broker 112 can also further optimize usage of network resources by switching providers with equivalent content and offerings. For example, the broker 112 may enable a streaming service can be replaced with a broadcast or cable delivery service if the network bandwidth is temporarily not available. Such a process may be made transparent to the user.

It is to be noted that, with respect to the described method, modifications may be proposed without departing from the scope of the invention. For instance, it is clear that this method may be implemented in several manners, such as by means of wired electronic circuits or, alternatively, by means of a set of instructions stored in a computer-readable medium, said instructions replacing at least a part of said circuits and being executable under the control of a computer or a digital processor in order to carry out the same functions as fulfilled in said replaced circuits. The invention is thus not limited to the examples provided.

The word “comprising” does not exclude the presence of other elements or steps than those listed in a claim.

1. A method of enabling to offer an information distribution service to an individual, the method comprising:
electronically presenting to the individual a plurality of information services of different providers, each service being respectively offered by one or more providers;
receiving a request from the individual for a specific one of the services; and,
enabling a selected provider to provide the specific service to the individual.

2. The method of claim 1, further comprising:
providing the individual with an electronic content distribution interface presenting the services.

3. The method of claim 1, further comprising:
maintaining a database comprising records associated with the one or more providers offering the specific service;
creating a profile of the user; and,
comparing the records and the profile to determine the selected provider.

4. The method of claim 1, wherein the selected provider is determined on the basis of the geographical location of the individual.

5. The method of claim 1, wherein the presenting does not enable the individual to identify the one or more providers offering one of the services.

6. The method of claim 1, further comprising:
enabling to identify one or more providers offering one of the services.

7. The method of claim 1, further comprising:
creating a profile of the individual; and,
enabling disclosing part of the profile to other individuals.

8. The method of claim 1, wherein the service is provided to increase market shares.

9. A device for enabling an information distribution service, the device comprising:
presentation means for providing an electronically presentation of a plurality of information services of different providers to an individual, each information service being respectively offered by one or more service providers;
a database of records of information services and respective providers; and,
selecting means for, upon selection of the individual of a specific service, enabling a selected provider to provide the specific service to the individual.

10. The device of claim 8, further comprising:
means for storing a profile of the individual; and,
wherein the selecting means determines the provider based on a comparison of the profile and selected records of service providers.

11. The device of claim 8, further comprising:
a customizing application for configuring a device of the individual to receive the specific service.

12. The device of claim 8, further comprising:
a mapping application for determining a new profile of the individual based on a new geographical location and the stored profile of the individual.

13. A software application comprising instructions for carrying out a method of providing a service to an individual, the method comprising:
electronically presenting to the individual a plurality of information services of different providers, each service being respectively offered by one or more providers; and,
upon reception of a request from the individual for a specific service,
enabling a selected provider to provide the specific service to the individual.
